(19) United States
(12) Patent Application Publication
(10) Pub. No.: US 2017/0164207 A1
(43) Pub. Date: Jun. 8, 2017

(54) METHODS AND APPARATUSES FOR SYNCHRONIZATION OF DISTRIBUTED HIERARCHICAL DATABASES

(71) Applicant: Nokia Technologies Oy, Espoo (FI)

(72) Inventor: Chittabrata GHOSH, Fremont, CA (US)

(21) Appl. No.: 15/309,960

(22) PCT Filed: May 19, 2014
(86) PCT No.: PCT/IB2014/061543

§ 371 Date: Nov. 9, 2016

(51) Int. Cl. H04W 16/14; G06F 17/30

(52) U.S. Cl. CPC H04W 16/14; G06F 17/30008; G06F 17/30174; G06F 17/30575

(57) ABSTRACT

A method, apparatus and computer program product are provided for synchronization of distributed hierarchal databases. A method is provided for assigning a channel set to a licensed shared access controller (LSAC). The channel set includes a plurality of channels and assigning the channel set includes associating the LSAC with the channel set in a channel set index. The method also includes receiving LSAC channel usage information and receiving incumbent channel usage information. The channel usage information is associated with the channels of the channel set. The method also includes mapping channel usage based on the LSAC channel usage information and incumbent channel usage information, and providing channel availability information for the channel set to the LSAC. The channel usage information is based on the mapped channel usage information.

An example embodiment of the present invention relates to data synchronization and, more particularly, to synchronization of distributed hierarchical databases.

### BACKGROUND

Regulatory requirements have previously denied the use of a radio channel if radar is detected within that range. Due to these regulations the coexistence of Wi-Fi, cellular, or other communications systems and radar systems was not possible. New regulations may allow for the radar bands, such as S band, e.g. 2-4 GHz, which have been restricted to military applications, to be released for secondary uses by communications systems such as Wi-Fi, long term evolution (LTE), 3rd generation partnership project (3GPP), or the like.

Unlike white space spectrum where database checking to prevent interference and collision, by a secondary communication system, was required to be renewed once every twenty-four hours, radar operations may change frequently, for example in hundreds of milliseconds. Therefore database synchronization techniques may be ineffective in sharing information in an environment with highly dynamic operational changes, and result in interference to sensitive radar detection operations.

### BRIEF SUMMARY

A method, apparatus and computer program product are provided in accordance with an example embodiment for synchronization of distributed hierarchical databases. In an example embodiment, a method is provided that includes assigning a channel set to a licensed shared access controller (LSAC). The channel set includes a plurality of channels and assigning the channel set includes associating the LSAC with the channel set in a channel set index. The method of this example embodiment also includes receiving channel usage information from the LSAC and receiving incumbent channel usage information. The LSAC channel usage information is associated with the channels of the channel set. The method of this example embodiment also includes mapping channel usage based on the LSAC channel usage information and incumbent channel usage information, and causing channel availability information for the channel set information set to be provided to the LSAC. The channel availability information is based on the mapped channel usage information.

In an example embodiment, the method also includes causing the channel list index to be provided to the LSAC. The channel set index includes a plurality of channel sets. The method of this example embodiment also includes receiving selected channel set indication. Assigning a channel set to the LSAC may be based on the selected channel indication. The method of this example embodiment also includes causing the transmission of an assigned channel set indication. In some example embodiments the method also includes parsing the channel availability information into channel set availability information. In an example embodiment of the method, the channels are S band channels.

In another example embodiment, a method is provided which includes receiving an assigned channel set indication. The channel set includes a plurality of channels. The method of this example embodiment also includes receiving channel usage information associated with respective channels of the channel set and causing the transmission of the channel usage information. In this example embodiment, the method also includes receiving channel availability information for the assigned channel set. The channel availability information is based on the channel usage information and incumbent usage information.

In an example embodiment of the method, the channels are S band channels. In a further example embodiment, the method includes receiving a channel list index. The channel set index includes a plurality of channel sets. The method of this example embodiment also includes selecting a channel set from the channel set index. Assigned channel set may be based on the selected channel indication. The method of this example embodiment also includes causing the transmission of a selected channel indication.

In an example embodiment, the method also includes determining an operating channel from the channel set based on the channel availability information.

In a further example embodiment, an apparatus is provided including at least one processor and at least one memory including computer program code with the at least one memory and computer program code configured to, with the processor, cause the apparatus to at least assign a channel set to a licensed shared access controller (LSAC). The channel set includes a plurality of channels and the assigning the channel set may include associating the LSAC with the channel set in a channel set index. The at least one memory and computer program code may be configured to, with the processor, cause the apparatus to also receive LSAC channel usage information and receive incumbent channel usage information. The LSAC channel usage information is associated with the channels of the channel set. The at least one memory and computer program code may also be configured to, with the processor, also cause the apparatus to map channel usage based on the LSAC channel usage information and incumbent channel usage information, and provide channel availability information for the channel set to the LSAC. The channel availability information is based on the mapped channel usage information.

In an example embodiment of the apparatus, the at least one memory and the computer program code are further configured to provide the channel list index to the LSAC and receive selected channel set indication. The channel set index includes a plurality of channel sets. Assigning a channel set to the LSAC may be based on the selected channel indication. The at least one memory and computer program code may be configured to, with the processor, also cause the apparatus to cause the transmission of an assigned channel set indication. In some example embodiments of the apparatus, the at least one memory and the computer program code are further configured to parse the channel availability information into channel set availability information. In an example embodiment of the apparatus, the channels are S band channels.

In another example embodiment, an apparatus is provided including at least one processor and at least one memory including computer program code with the at least one memory and computer program code configured to, with the processor, cause the apparatus to at least receive an assigned channel set indication. The channel set includes a plurality of channels. The at least one memory and computer program code may be configured to, with the processor, cause the apparatus to also receive channel usage information associated with respective channels of the channel set, cause the transmission of the channel usage information, and receive channel availability information for the assigned channel set. The channel availability information is based on the channel usage information and the incumbent channel usage information.

In an example embodiment of the apparatus the channels are S band channels. In some example embodiments of the apparatus, the at least one memory and the computer program code are further configured to receive a channel list index. The channel set index includes a plurality of channel sets. The at least one memory and computer program code may be configured to, with the processor, cause the apparatus to also select a channel set from the channel set index. The assigned channel set may be based on the selected channel indication. The at least one memory and computer program code may be configured to, with the processor, cause the apparatus to also cause the transmission of a selected channel indication.

In some example embodiments of the apparatus, the at least one memory and the computer program code are further configured to determine an operating channel from the channel set based on the channel availably information.

In yet another example embodiment, a computer program product is provided including at least one non-transitory computer-readable storage medium having computer-executable program portions stored therein with the computer-executable program code portions comprising program code instructions configured to assign a channel set to a licensed shared access controller (LSAC). The channel set includes a plurality of channels. The assigning the channel set may include associating the LSAC with the channel set in a channel set index. The computer-executable program code portions of this example embodiment comprise program code instructions configured to also receive LSAC channel usage and receive incumbent channel usage information. The LSAC channel usage information may be associated with the channels of the channel set. The computer-executable program code portions of this example embodiment comprise program code instructions configured to also map channel usage based on the LSAC channel usage information and incumbent channel usage information, and cause channel availability information for the channel set to be provided to the LSAC. The channel availability information is based on the mapped channel usage information.

In an example embodiment of the computer program product, the computer-executable program code portions further comprise program code instructions configured to provide the channel list index to the LSAC. The channel set index includes a plurality of channel sets. The computer-executable program code portions of this example embodiment comprise program code instructions configured to also receive selected channel set indication. The assigned channel set may be based on the selected channel indication. The computer-executable program code portions of this example embodiment may comprise program code instructions configured to also cause the transmission of an assigned channel set indication.

In some example embodiments of the computer program product, the computer-executable program code portions further comprise program code instructions configured to parse the channel availability information into channel set availability information. In an example embodiment of the computer program product, the channels are S band channels.

In a further example embodiment, a computer program product is provided including at least one non-transitory computer-readable storage medium having computer-executable program portions stored therein with the computer-executable program code portions comprising program code instructions configured to receive an assigned channel set indication. The channel set includes a plurality of channels. The computer-executable program code portions of this example embodiment comprise program code instructions configured to also receive channel usage information associated with respective channels of the channel set, cause the transmission of the channel usage information, and receive channel availability information for the assigned channel set. The channel availability information is based on the channel usage information and the incumbent channel usage information.

In an example embodiment of the computer program product, the channels are S band channels. In some example embodiments of the computer program product, the computer-executable program code portions further comprise program code instructions configured to receive a channel list index. The channel set index includes a plurality of channel sets. The computer-executable program code portions of this example embodiment comprise program code instructions configured to also select a channel set from the channel set index and cause the transmission of a selected channel indication. The assigning a channel set to the LSAC is based on the selected channel indication.

In some example embodiments of the computer program product, the computer-executable program code portions further comprise program code instructions configured to determine an operating channel from the channel set based on the channel availability information

In yet another example embodiment, an apparatus is provided that includes means for assigning a channel set to a licensed shared access controller (LSAC). The channel set includes a plurality of channels and assigning the channel set includes associating the LSAC with the channel set in a channel set index. The apparatus of this example embodiment also includes means for receiving LSAC channel usage information from the LSAC and receiving incumbent channel usage information. The LSAC channel usage information is associated with the channels of the channel set. The apparatus of this example embodiment also includes means for mapping channel usage based on the LSAC channel usage information and incumbent channel usage information, and causing channel availability information for the channel set to be provided to the LSAC. The channel availability information is based on the mapped channel usage information.

In still a further example embodiment, an apparatus is provided that includes means for receiving an assigned channel set indication. The channel set includes a plurality of channels. The apparatus of this example embodiment also includes means for receiving channel usage information associated with respective channels of the channel set, means for causing the transmission of the channel usage information, and means for receiving channel availability information for the assigned channel set. The channel availability information is based on the channel usage information and the incumbent channel usage information.

### BRIEF DESCRIPTION OF THE DRAWINGS

Having thus described example embodiments of the invention in general terms, reference will now be made to the accompanying drawings, which are not necessarily drawn to scale, and wherein:

FIG. 1 illustrates a communications diagram in accordance with an example embodiment of the present invention;

FIG. 2 illustrates three tier cloud network architecture in accordance with an example embodiment of the present invention;

FIG. 3 is a block diagram of an apparatus that may be specifically configured for synchronization of distributed hierarchical databases in accordance with an example embodiment of the present invention; and

FIGS. 4 and 5 are a flow charts illustrating the operations performed, such as by the apparatus of FIG. 3, in accordance with an example embodiment of the present invention.

### DETAILED DESCRIPTION

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ refers to (a) hardware-only circuit implementations (for example, implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein, a “computer-readable storage medium,” which refers to a non-transitory physical storage medium (for example, volatile or non-volatile memory device), can be differentiated from a “computer-readable transmission medium,” which refers to an electromagnetic signal.

### System Architecture of Radar and Communications Systems in Radar Bands

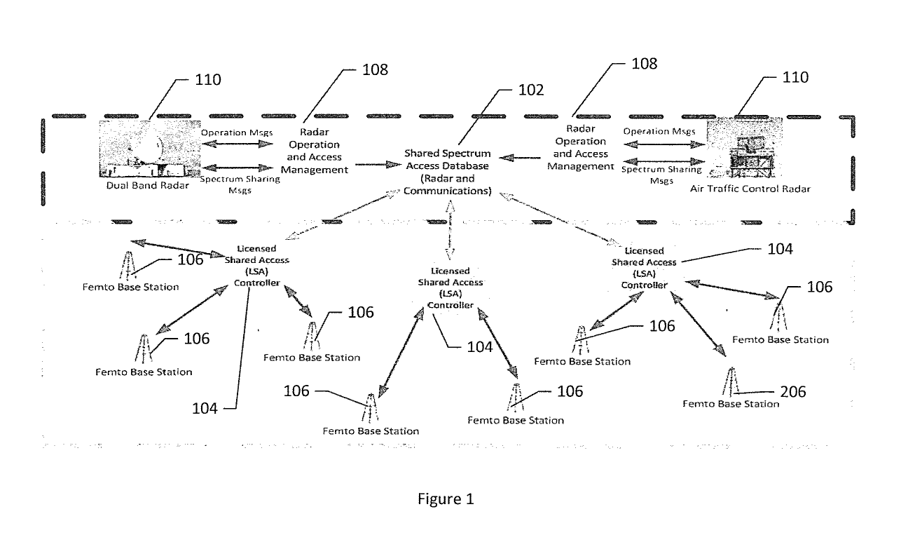

A method, apparatus and computer program product are provided in accordance with an example embodiment for synchronization of distributed hierarchical databases. FIG. 1 illustrates a communication diagram including a shared spectrum access database (SSAD) 102, in communications with one or more licensed shared access controllers (LSAC) 104. The LSAC 104 may be in communication with one or more base stations 106. The SSAD 102 may be in communication with one or more radar operation and management systems 108, which may control and monitor the operation of a radar system 110, such as dual band radar, air traffic control radar, or the like.

The radar operation and access management system 108 may communicate operational messages to the radar systems 110 and send and receive spectrum sharing messages. The spectrum sharing messages may include the channel on which the radar system is operating and/or usage information. The SSAD 102 may be a radio frequency management database, for collection of radar system 110 operational parameters, for example channel usage sustainable interference, or the like, and secondary communications systems and providing channel availability information to the LSACs 104. The SSAD 102 may receive usage information from the radar operation and access management systems 108. The usage information may be for one or more channels in which the radar is operating or may operate. The channel usage information for radar system is herein referred to as “incumbent channel usage,” as radar systems may have priority over all other traffic.

The radar operation information may be classified and therefore may not be shared with communications systems, such as Wi-Fi and cellular services. The LSAC 104 may be a management communications management system which receives the radar operational parameters, for example, channel usage by radar from the SSAD 102 and determines operating parameters of communications systems, for example, operating channels. The LSAC 104 may be a secured source, e.g. authenticated, which may be allowed to access partial information of radar use in the radar band, such as S band 2-4 GHz. The LSACs 104 may communicate with the SSAD 102 to synchronize the available channels for communication service use by the base stations 106.

### Cloud Network Architecture

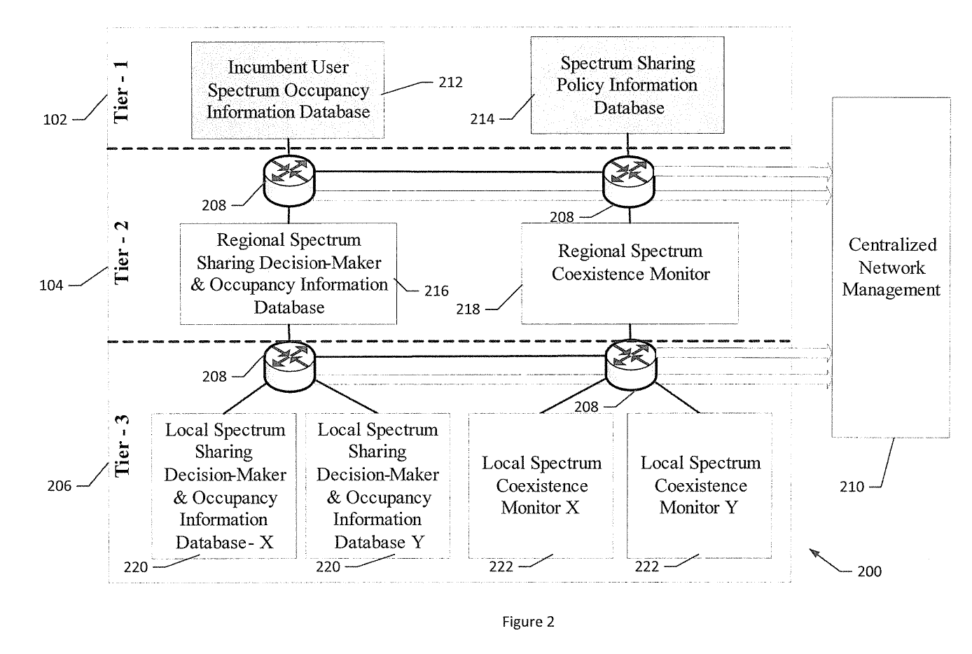

FIG. 2 illustrates a three tiered cloud network architecture in an example embodiment of the present invention. The network 200 may include one or more SSAD 102, LSAC 104, and local controllers 206. The SSAD 102, LSAC 104, and local controllers 206 may be one or more physical or cloud modules, such as databases or controllers, e.g. decision makers. The cloud modules may be connected by dynamically connected networking elements, such as configurable routers 208. The routers 208 may be configured and controlled with customized routing and information sharing policies by the central network management module 210. In an example embodiment, the three tier cloud network 200 is a software defined network.

Tier 1 may include one or more SSADs 102. The SSADs 102 may include an incumbent user spectrum occupancy information database 212 which may receive radar system 110, e.g. incumbent, channel usage. The SSAD 102 may also include a spectrum sharing policy information database, which may provide policies for sharing a radio spectrum, such as radar band, e.g. S band 2-4 GHz, between radar systems 110 or with communication services, such as Wi-Fi or cellular. The policies may include allowable transmission power, spectral mask, adjacent power leakage, or the like

Tier 2 may include one or more LSACs 102. The LSACs 102 may include modules including a regional spectrum sharing decision maker and occupancy information database 216 and a regional spectrum coexistence monitor 218. The regional spectrum sharing decision maker and occupancy information database 216 may determine whether to use the spectrum for communications sharing using the policies provided by the spectrum sharing policy information database 214. The regional spectrum coexistence monitor 218 may advocate the performance of the communications system due to sharing the spectrum with the radar system 110 by monitoring and reporting communications system performance. For example, if the regional spectrum coexistence monitor 218 reports a performance degradation at regional network such as, a Wi-Fi or LTE network, the regional spectrum sharing decision maker and occupancy information database, may decide to stay on the same channel coexisting with the radar, switch to a new channel, or the like. In an example embodiment, there may be a regional spectrum sharing decision maker and occupancy information database 216 and/or a regional coexistence monitor 218 for each of a plurality of defined geographical areas, administered by the respective service providers.

Tier 3 may include one or more local controllers 206. The local controller 206 may be a controller associated with a base station 106, or the like, for secondary communication systems, such as Wi-Fi, cellular, or the like. The local controller 206 may have modules including one or more local spectrum sharing decision maker and occupancy information database 220, local spectrum coexistence spectrum coexistence monitor 222, or the like. The local spectrum sharing decision maker and occupancy information database 220 may operate in a manner substantially similar to the regional spectrum sharing decision maker and occupancy information database 216 with regard to a local communication system. Similarly, the local spectrum coexistence monitor 222 may operate in a manner substantially similar to the regional spectrum coexistence monitor 218 with regard to a local communications system.

In an instance in which the LSAC 104 establishes an initial connection with the SSAD 102, the LSAC may receive a channel set index. The channel set index may include a plurality of radio frequency channel sets, e.g. 3, 5, 10, or any other number of channels, allowed sets of modulations for each channel, adjacent channel interference tolerance limits, or the like. One of ordinary skill in the art would appreciate that the term channel and frequency may be used interchangeably. The LSAC 104 may select a channel set as a preferred channel set from the channel set index and transmit a selected channel set indication to the SSAD. The SSAD may assign the LSAC the channel set by associating the LSAC with the channel set in the channel set index. In an embodiment in which a selected channel set indication is received, the processor 302 may assign the selected channel set or use the selected channel set as a factor in determining the channel set to assign. Additionally or alternatively, the processor 302 may use the current or anticipated channel usage rates to determine the assigned channel sets.

The LSAC may allow the local controller 206 to use one or more of the channels of the channel set for Wi-Fi or cellular communications. The local controller may transmit channel usage information to the LSAC 104 repeatedly, such as continuously, near continuously, or for each change in usage. The LSAC 104 may aggregate the channel usage information received from the respective controllers and transmit aggregate channel usage information of the channel set to the SSAD 102 repeatedly, such as such as continuously, near continuously, or for each change in usage.

The SSAD 102 may map the LSAC 104 channel usage and the incumbent channel usage for the respective channels of the channel set index. Mapping may include a one-to one mapping of the channel identifications (IDs) used by the radar system with the channel IDs in the channel set, in an instance in which there is a common ID in the channel set and a channel used by the radar system 110. For example, the SSAD 102 may return a 0 in an instance in which there is no common channel between channel IDs of the channel used by the radar and the channel IDs of the channel in the channel set. The mapping may result in two values, the first may be the number of channels mapped and the second may be the channel IDs of the mapped channels. The SSAD 102 may parse the mapped channel usage into each respective channel of the channel set, generating channel availability information for each channel set and each channel.

The LSAC 104 may be configured to search or request the channel availability of the assigned channel set from the SSAD 102 at a predetermined interval, such as 100 ms, 1 s, 30 s, or any other time value. Additionally or alternatively the SSAD 102 may be configured to provide the channel availability information to the LSAC 104 for the assigned channel set, such as by allowing the LSAC to search the channel availability information or transmitting the channel availability information to the LSAC.

The LSAC 104 may determine one or more channels as operating channels based on the channel availability information for the channel set. For example, one or more of the channels in the channel set may be in use by the radar system 110 and therefore unavailable. The LSAC 104 may determine one or more of the available channels as operating channels and allow the local controller 206 to communicate using those channels. In an instance in which channel availability information indicates that a channel, which is in use, is no longer available, the LSAC 102 and/or the local controller 206 may shift the communications from the unavailable channel to another channel of the assigned channel set.

By limiting the channel availability information to the assigned channel set the database synchronization latency, e.g. the time that the SSAD and LSAC databases channel availability are unsynchronized, is substantially reduced. The reduction in database latency may minimize interference to sensitive radar detection, thus allowing use of the radar band by communications systems.

### Example Apparatus

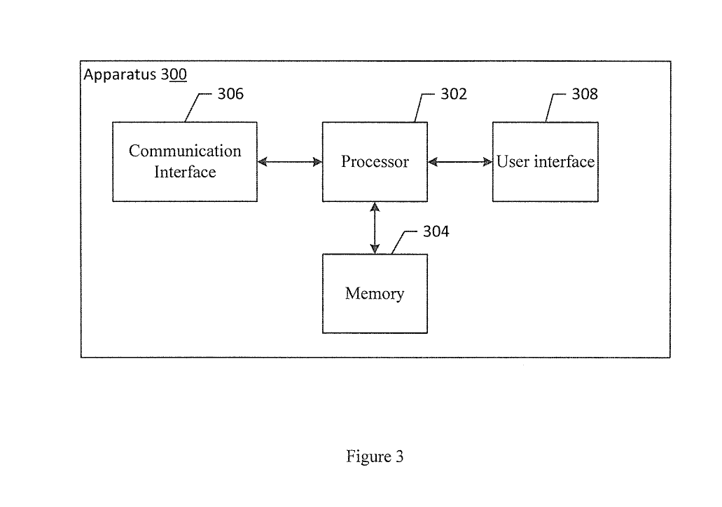

A SSAD 102 or the LSAC 104 may include or otherwise be associated or in communication with an apparatus 300 as shown in FIG. 3. The apparatus, such as that shown in FIG. 3, is specifically configured in accordance with an example embodiment of the present invention to provide for synchronization of distributed hierarchical databases. The apparatus may include or otherwise be in communication with a processor 302, a memory device 304, a communication interface 306, and optionally a user interface 308. In some embodiments, the processor (and/or co-processors or any other processing circuitry assisting or otherwise associated with the processor) may be in communication with the memory device via a bus for passing information among components of the apparatus. The memory device may be non-transitory and may include, for example, one or more volatile and/or non-volatile memories. In other words, for example, the memory device may be an electronic storage device (for example, a computer readable storage medium) comprising gates configured to store data (for example, bits) that may be retrievable by a machine (for example, a computing device like the processor). The memory device may be configured to store information, data, content, applications, instructions, or the like for enabling the apparatus to carry out various functions in accordance with an example embodiment of the present invention. For example, the memory device could be configured to buffer input data for processing by the processor. Additionally or alternatively, the memory device could be configured to store instructions for execution by the processor.

As noted above, the apparatus 300 may be embodied by a SSAD 102 or LSAC 104. However, in some embodiments, the apparatus may be embodied as a chip or chip set. In other words, the apparatus may comprise one or more physical packages (for example, chips) including materials, components and/or wires on a structural assembly (for example, a baseboard). The structural assembly may provide physical strength, conservation of size, and/or limitation of electrical interaction for component circuitry included thereon. The apparatus may therefore, in some cases, be configured to implement an embodiment of the present invention on a single chip or as a single “system on a chip.” As such, in some cases, a chip or chipset may constitute means for performing one or more operations for providing the functionalities described herein.

The processor 302 may be embodied in a number of different ways. For example, the processor may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor may include one or more processing cores configured to perform independently. A multi-core processor may enable multiprocessing within a single physical package. Additionally or alternatively, the processor may include one or more processors configured in tandem via the bus to enable independent execution of instructions, pipelining and/or multithreading.

In an example embodiment, the processor 302 may be configured to execute instructions stored in the memory device 304 or otherwise accessible to the processor. Alternatively or additionally, the processor may be configured to execute hard coded functionality. As such, whether configured by hardware or software methods, or by a combination thereof, the processor may represent an entity (for example, physically embodied in circuitry) capable of performing operations according to an embodiment of the present invention while configured accordingly. Thus, for example, when the processor is embodied as an ASIC, FPGA or the like, the processor may be specifically configured hardware for conducting the operations described herein. Alternatively, as another example, when the processor is embodied as an executor of software instructions, the instructions may specifically configure the processor to perform the algorithms and/or operations described herein when the instructions are executed. However, in some cases, the processor may be a processor of a specific device (for example, a mobile terminal or a fixed computing device) configured to employ an embodiment of the present invention by further configuration of the processor by instructions for performing the algorithms and/or operations described herein. The processor may include, among other things, a clock, an arithmetic logic unit (ALU) and logic gates configured to support operation of the processor.

The apparatus 300 of an example embodiment may also include a communication interface 306 that may be any means such as a device or circuitry embodied in either hardware or a combination of hardware and software that is configured to receive and/or transmit data from/to a communications device in communication with the apparatus, such as to facilitate communications with one or more user equipment 110, utility device, or the like. In this regard, the communication interface may include, for example, an antenna (or multiple antennas) and supporting hardware and/or software for enabling communications with a wireless communication network. Additionally or alternatively, the communication interface may include the circuitry for interacting with the antenna(s) to cause transmission of signals via the antenna(s) or to handle receipt of signals received via the antenna(s). In some environments, the communication interface may alternatively or also support wired communication. As such, for example, the communication interface may include a communication modem and/or other hardware and/or software for supporting communication via cable, digital subscriber line (DSL), universal serial bus (USB) or other mechanisms.

The apparatus 300 may also include an optional user interface 308 that may, in turn, be in communication with the processor 302 to provide output to the user and, in some embodiments, to receive an indication of a user input. As such, the user interface may include a display and, in some embodiments, may also include a keyboard, a mouse, a joystick, a touch screen, touch areas, soft keys, one or more microphones, a plurality of speakers, or other input/output mechanisms. In one embodiment, the processor may comprise user interface circuitry configured to control at least some functions of one or more user interface elements such as a display and, in some embodiments, a plurality of speakers, a ringer, one or more microphones and/or the like. The processor and/or user interface circuitry comprising the processor may be configured to control one or more functions of one or more user interface elements through computer program instructions (for example, software and/or firmware) stored on a memory accessible to the processor (for example, memory device 304, and/or the like).

### Example Processes for Synchronization of Distributed Hierarchical Databases

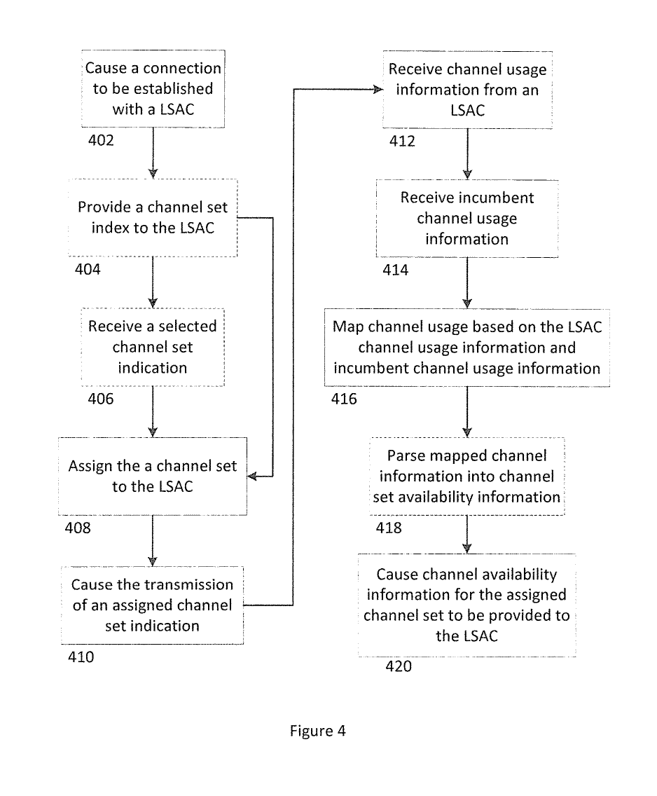

Referring now to FIG. 4, the operations performed, such as by the apparatus 300 of FIG. 3, for synchronization of distributed hierarchical databases are depicted. In the following example, the apparatus may be embodied or otherwise associated or in communication with a SSAD, such as SSAD 102 of FIG. 1 or 2. As shown in block 402 of FIG. 4, the apparatus 300 may include means, such as a processor 302, a communications interface 306, or the like, configured to cause a connection to be established with a LSAC. The processor 302 may cause the communications interface 306 to establish a data communications connection with a LSAC 104 using wired or wireless communication. In an example embodiment, the establishment of the connection is in response to a connection request from the LSAC 104.

As shown in block 404 of FIG. 4, the apparatus 300 may include means, such as a processor 302, a communications module 306, or the like, configured to provide a channel set index to the LSAC 104. The channel set index may include a plurality of radio frequency channel sets, e.g. 3, 5, 10, or any other number of channels and/or individual channels. The processor 302 may cause the communications interface 306 to transmit the channel set index to the LSAC 104.

In an example embodiment, the process may continue at block 406 receiving an selected channel indication from the LSAC 104 and then proceed to block 408 assigning a channel set to the LSAC. Alternatively, the system design configuration may cause the process to proceed directly to 408 assigning the channel set to the LSAC. The

As shown at block 406, of FIG. 4, the apparatus 300 of an example embodiment may include means, such as a processor 302, communication interface 306, or the like, configured to receive a selected channel set indication. The selected channel set indication may be an indication of one or more channels or a set of channels from the channel set index, which have been selected by the LSAC 104 from the channel set index as a preferred channel set. The processor 302 may receive the selected channel set indication from the communications interface 306 and in some example embodiments store the selected channel set indication in a memory 304 such as the incumbent user spectrum occupancy database 212.

As shown at block 408 of FIG. 4, the apparatus 300 may include means, such as a processor 302, or the like, configured to assign a channel set to the LSAC 104. In an embodiment in which a selected channel set indication is received, the processor 302 may assign the selected channel set or use the selected channel set as a factor in determining the channel set to assign. Additionally or alternatively, the processor 302 may use the current or anticipated channel usage rates to determine the assigned channel sets. The processor 302 may assign the channel set to the LSAC 104 by associating the LSAC with the channel set in the channel set index.

As shown at block 410 of FIG. 4, the apparatus 300 may include means, such as a processor 302, a communications interface 306, or the like, configured to cause the transmission of the assigned channel set indication. The processor 302 may cause the communications interface 306 to transmit the assigned channel set indication to the respective LSAC 104.

As shown at block 412 of FIG. 4, the apparatus 300 may include means, such as a processor 302, communications interface 306, or the like, configured to receive channel usage information from the LSAC 104. The channel usage information may be the aggregate channel usage information for each channel assigned to the LSAC 104. The processor 302 may receive the channel usage information from the LSAC repeatedly, such as such as continuously, near continuously, or for each change in usage.

As shown at block 414 of FIG. 4, the apparatus 300 may include means, such as a processor 302, communications interface 306, or the like, configured to receive incumbent channel usage information. The processor 302 may receive incumbent channel usage information from the communications interface 306, which in turn, may receive the incumbent channel usage information from a radar operations and access management system such as 108 or an incumbent user spectrum occupancy information database, such as 212. The incumbent channel usage information may be indicative of dual band radar, air traffic control radar, or the like, usage on one or more of the channels associated with the channel set index. The incumbent channel usage information may be received by the processor 302 repeatedly, such as such as continuously, near continuously, or for each change in usage or anticipated usage.

As shown at block 416 of FIG. 4, the apparatus 300 may include means, such as a processor 302, or the like, configured to map channel usage based on the LSAC channel usage and the incumbent channel usage. The processor 302 may map the aggregate channel usage for respective LSACs and incumbent usage.

As shown at block 418 of FIG. 4, the apparatus 300 may include means, such as a processor 302, or the like, configured to parse the mapped channel usage information into channel set availability information. The channel set availability information may include an indication of the channels of the channel set that are open for use by the LSAC, channels which are partially available for use, e.g. some bandwidth available, and channels which are closed to use.

A shown at block 420 of FIG. 4, the apparatus 300 may include means, such as a processor 302, communications interface 306, or the like, configured to cause channel availability information for the assigned channel set to be provided to the respective LSAC 104. In some embodiments, the channel availability information provided is limited to the assigned channel set of a respective LSAC 104. The channel availability information may be used by the LSAC 104 to assign an operating channel to local controllers, such as local controller 206 for Wi-Fi or Cellular communications.

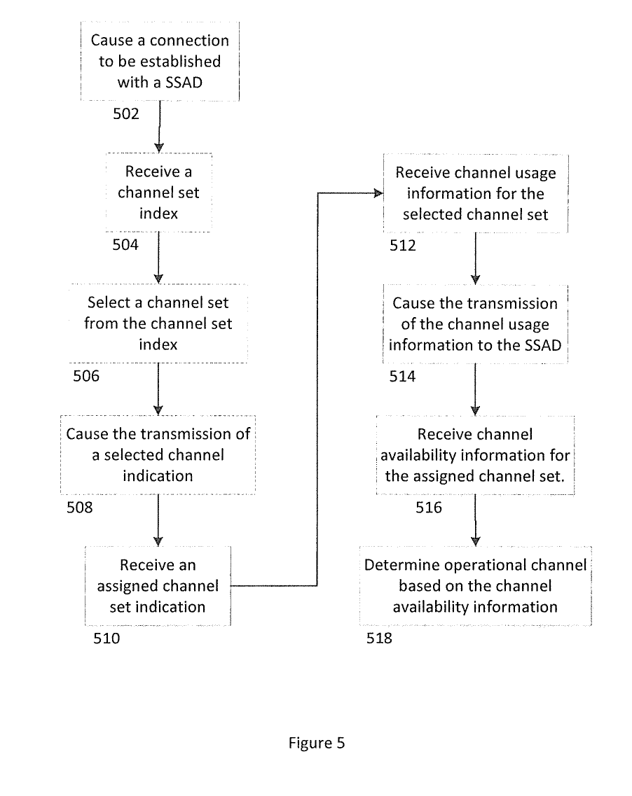

Referring to FIG. 5, the operations performed, such as by the apparatus 300 of FIG. 3, for synchronization of distributed hierarchical databases are depicted. In the following example, the apparatus 300 may be embodied or otherwise associated or in communication with a LSAC, such as LSAC 104 of FIG. 1 or 2. As shown at block 502 of FIG. 5, the apparatus 300 may include means, such as a processor 302, a communications interface 306, or the like, configured to cause a connection to be established with a SSAD 102. The processor 302 may cause the communications interface 306 to transmit a connection request to the SSAD 102 and/or cause a connection with a SSAD to be established using wired or wireless communication.

As shown at block 504 of FIG. 5, the apparatus 300 may include means, such as a processor 302, communications interface 306, or the like, configured to receive a channel set index. The channel set index may include a plurality of radio frequency channel sets, e.g. 3, 5, 10, or any other number of channels and/or individual channels. The processor 302 may receive the channel set index form the communications interface 306 which, in turn, received the channel set index from the SSAD 102.

As shown in block 506 of FIG. 5, the apparatus 300 may include means, such as a processor 302, or the like, configured to select a channel set from the channel set index. The processor 302 may select a channel set from a plurality of channel sets, select a partial channel set, and/or select individual channels. The processor 302 may aggregate selected channels into a channel set.

As shown at block 508 of FIG. 5, t apparatus 300 may include means, such as a processor 302, or the like, configured to cause the transmission of the selected channel set indication. The processor 302 may cause the communications interface 306 to transmit the selected channel set indication to the SSAD 102.

As shown at block 510 of FIG. 5, the apparatus 300 may include means, such as a processor 302, communications interface 306, or the like, configured to receive an assigned channel set indication. The processor 302 may receive the assigned channel set indication from the communications interface 306, which in turn receives the assigned channel set indication from the SSAD 102. The assigned channel set may indicate the channels which are assigned for use by the apparatus 300.

As shown at block 512 of FIG. 5, the apparatus 300 may include means, such as a processor 302, communications interface 306, or the like, configured to receive channel usage information. The processor 302 may receive channel usage information from the communications interface 306, which may in turn receive the channel usage information from respective local controllers, such as local controller 206. The processor 302 may aggregate the channel usage information of the individual channels to generate channel usage information for the channel set.

As shown at block 514 of FIG. 5, the apparatus 300 may include means, such as a processor 302, communications interface 306, or the like, configured to cause the transmission of the channel usage information. The processor 302 may cause the communications interface 306 to transmit the channel usage information to the SSAD 104 repeatedly, such as such as continuously, near continuously, or for each change in usage.

As shown at block 516 of FIG. 5, the apparatus 300 may include means, such as a processor 302, communications interface 306, or the like, configured to receive channel availability information. The channel availability information may include which channels of the channel set are open for use by the LSAC, channels which are partially available for use, e.g. some bandwidth available, and channels which are closed to use. The channel availability information may be received repeatedly, such as such as continuously, near continuously, or for each change in usage. Additionally or alternatively the channel availability information may be received in response to a request or search sent to the SSAD 102. In some example embodiments, the channel availability information is a channel set availability information excluding channel availability information for unassigned channels.

As shown at block 518 of FIG. 5, the apparatus 300 may include means, such as a processor 302, or the like, configured to determine an operational channel based on the availability information. For example, one or more of the channels in the channel set may be in use by the radar system 110 and therefore unavailable. The processor 302 may determine one or more of the available channels as operating channels and allow the local controller 206 to communicate using those channels. In an instance in which the channel availability information indicates that a channel that is in use is no longer available, the processor 302 and/or the local controller 206 may shift the communications from the unavailable channel to another channel of the assigned channel set.

By limiting the channel availability information to the assigned channel set the database synchronization latency, e.g. the time that the SSAD and LSAC databases channel availability are unsynchronized is substantially reduced. The reduction in database latency may minimize interference to sensitive radar detection, thus allowing use of the radar band by communications systems.

As described above, FIGS. 4 and 5 illustrate flowcharts of an apparatus 300, method, and computer program product according to example embodiments of the invention. It will be understood that each block of the flowcharts, and combinations of blocks in the flowcharts, may be implemented by various means, such as hardware, firmware, processor, circuitry, and/or other communication devices associated with execution of software including one or more computer program instructions. For example, one or more of the procedures described above may be embodied by computer program instructions. In this regard, the computer program instructions which embody the procedures described above may be stored by a memory device 304 of an apparatus employing an embodiment of the present invention and executed by a processor 302 of the apparatus. As will be appreciated, any such computer program instructions may be loaded onto a computer or other programmable apparatus (for example, hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowcharts support combinations of means for performing the specified functions and combinations of operations for performing the specified functions for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

In some embodiments, certain ones of the operations above may be modified or further amplified. Furthermore, in some embodiments, additional optional operations may be included, such as illustrated by the dashed outline of block 404, 406, 418, 504, 506, and 508 in FIGS. 4 and 5. Modifications, additions, or amplifications to the operations above may be performed in any order and in any combination.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1-24. (canceled)

25. A method comprising:
assigning a channel set to a licensed shared access controller (LSAC), wherein the channel set comprises a plurality of channels; wherein assigning the channel set comprises associating the LSAC with the channel set in a channel set index;
receiving LSAC channel usage information, wherein the LSAC channel usage information is associated with the channels of the channel set;
receiving incumbent channel usage information;
mapping channel usage based on the channel usage information; and
causing channel availability information for the channel set to be provided to the LSAC, wherein the channel availability information is based on the mapped channel usage information.

26. The method of claim 25 further comprising:
causing the channel list index to be provided to the LSAC, wherein the channel set index comprises a plurality of channel sets;
receiving selected channel set indication;
wherein the assigning a channel set to the LSAC is based on the selected channel indication; and
causing the transmission of an assigned channel set indication.

27. The method of claim 25 further comprising:
parsing the channel availability information into channel set channel availability information.

28. The method of claim 25, wherein the channels are S band channels.

29. A method comprising:
receiving an assigned channel set indication, wherein the channel set comprises a plurality of channels;
receiving channel usage information associated with respective channels of the channel set;
causing the transmission of the channel usage information; and
receiving channel availability information for the channel set, wherein the channel availability information is based on the channel usage information and incumbent channel usage information.

30. The method of claim 29, wherein the channels are S band channels.

31. The method of claim 29 further comprising:
determining an operating channel from the channel set based on the channel availability information.

32. The method of claim 29 further comprising:
receiving a channel list index, wherein the channel set index comprises a plurality of channel sets; and
selecting a channel set from the channel set index; and
causing the transmission of a selected channel indication;
wherein the assigned channel set is based on the selected channel indication.

33. An apparatus comprising at least one processor and at least one memory including computer program code, the at least one memory and computer program code configured to, with the processor, cause the apparatus to at least:
assign a channel set to a licensed shared access controller (LSAC), wherein the channel set comprises a plurality of channels; wherein assigning the channel set comprises associating the LSAC with the channel set in a channel set index;
receive LSAC channel usage information, wherein the LSAC channel usage information is associated with the channels of the channel set;
receive incumbent channel usage information;
map channel usage based on the LSAC channel usage information and incumbent channel usage information; and
cause channel availability information for the channel set to be provided to the LSAC, wherein the channel availability information is based on the mapped channel usage information.

34. The apparatus of claim 33, wherein the at least one memory and the computer program code are further configured to:
provide the channel list index to the LSAC, wherein the channel set index comprises a plurality of channel sets;
receive selected channel set indication;
wherein the assigning a channel set to the LSAC is based on the selected channel indication; and
cause the transmission of an assigned channel set indication.

35. The apparatus of claim 33, wherein the at least one memory and the computer program code are further configured to:
parse the channel availability information into channel set availability information.

36. The apparatus of claim 33, wherein the channels are S band channels.

37. An apparatus comprising at least one processor and at least one memory including computer program code, the at least one memory and computer program code configured to, with the processor, cause the apparatus to at least:
receive an assigned channel set indication, wherein the channel set comprises a plurality of channels;
receive channel usage information associated with respective channels of the channel set;
cause the transmission of the channel usage information; and
receive channel availability information, wherein the channel availability information is based on the channel usage information and incumbent channel usage information.

38. The apparatus of claim 37, wherein the channels are S band channels.

39. The apparatus of claim 37, wherein the at least one memory and the computer program code are further configured to:
receive a channel list index, wherein the channel set index comprises a plurality of channel sets;
select a channel set from the channel set index; and
cause the transmission of a selected channel indication;
wherein the assigned channel set is based on the selected channel indication.

40. The apparatus of claim 37, wherein the at least one memory and the computer program code are further configured to:
determine an operating channel from the channel set based on the channel availability information.

41. A computer program product comprising at least one non-transitory computer-readable storage medium having computer-executable program portions stored therein, the computer-executable program code portions comprising program code instructions configured to:
assign a channel set to a licensed shared access controller (LSAC), wherein the channel set comprises a plurality of channels; wherein assigning the channel set comprises associating the LSAC with the channel set in a channel set index;
receive LSAC channel usage information, wherein the LSAC channel usage information is associated with the channels of the channel set;
receiving incumbent channel usage information;
map channel usage based on the LSAC channel usage information and incumbent channel usage information; and
cause channel availability information for the channel set to be provided to the LSAC, wherein the channel availability information is based on the mapped channel usage information.

42. The computer program product of claim 41, wherein the computer-executable program code portions further comprise program code instructions configured to:
cause the channel list index to be provided to the LSAC, wherein the channel set index comprises a plurality of channel sets;
receive selected channel set indication;
wherein the assigning a channel set to the LSAC is based on the selected channel indication; and
cause the transmission of an assigned channel set indication.

43. The computer program product of claim 41, wherein the computer-executable program code portions further comprise program code instructions configured to:
parse the channel availability information into channel set availability information.

44. The computer program product of claim 43, wherein the channels are S band channels.
